(19) United States
(12) Patent Application Publication
(10) Pub. No.: US 2022/0212380 A1
(43) Pub. Date: Jul. 7, 2022

(54) MANUFACTURING METHOD AND AN INJECTION MOLDING SYSTEM

(71) Applicant: Canon Virginia, Inc., Newport News, VA (US)

(72) Inventors: Koki Kodaira, Tokyo (JP); Yuichi Yanahara, Moriyama (JP)

(21) Appl. No.: 17/611,389

(22) PCT Filed: May 13, 2020
(86) PCT No.: PCT/US20/32743

§ 371 Date: Nov. 15, 2021

Related U.S. Application Data
(60) Provisional application No. 62/849,757, filed on May 17, 2019.

(51) Int. Cl. B29C 45/04; B29C 45/17; B29C 45/76; B29C 45/73

(52) U.S. Cl. CPC B29C 45/0408; B29C 45/1756; B29C 45/762; B29C 45/7306; B29C 2945/76648; B29C 2945/76859; B29C 2945/76903; B29C 2945/76535; B29C 2945/76896

(57) ABSTRACT

A method manufacturing a molded part with an injection molding machine including conveying a first mold between a first position for injection processing and a second position for a cooling process, conveying a second mold between the first position and a third position for performing the cooling process, performing the injection process on the mold located at the first position, removing a molded part from the mold after the cooling process, exchanging the first mold for a third mold when a number of molded parts associated with the first mold are removed reaches a predetermined number, wherein the second mold and the third mold are conveyed, and controlling, during at least a part of exchanging the first mold and the third mold such that the injection process, the cooling process, and the removing are performed without conveying the second mold between the first position and the third position

### CROSS-REFERENCE to RELATED APPLICATION

This application claims the benefit of U.S. Provisional Application 62/849757, which was filed on May 17, 2019.

### FIELD

The present disclosure relates to an injection molding system.

### BACKGROUND

Manufacturing of molded parts by an injection molding machine includes injecting a resin into a mold after clamping the mold, pressing the resin into the mold at a high pressure in order to compensate for a volume decrease due to solidification of the resin, keeping the molded part in the mold until the resin solidifies, and ejecting the molded part from the mold.

In the above-described molding approach, a method that uses two molds with one injection molding machine in order to enhance productivity has been proposed. For example, US 2018/0009146/Japanese patent publication No. 2018-001738/VN20160002505 are seen to discuss a system in which conveying devices 3A and 3B are arranged on both sides of an injection molding machine 2. In this system, molded parts are manufactured while alternating a plurality of molds by the conveying devices 3A and 3B for the one injection molding machine 2. FIG. 1 illustrates an injection molding system of US 2018/0009146/ Japanese patent publication No. 2018-001738/VN20160002505.

In this system, cooling of the molds 100A or 100B is performed on the conveying machines 3A or 3B outside of the injection molding machine 2. During cooling of one of the molds 100A/100B, each process of molded part ejection→clamping→injection/dwelling is performed by the injection molding machine 2 for the other mold 100A/100B. Since opening and molded part ejection are performed by the injection molding machine 2, the conveying machines 3A and 3B do not need a function for opening and a function for molded part ejection.

This enables manufacture of the molded part P while alternating the plurality of the molds by the one injection molding machine 2. This can reduce the overall cost of the system.

If the time required for all processes from the start of the mold replacement process, to the other mold ejecting process, injection process, and dwelling process, and up until completion of FS1.

the mold replacement process once again fits into the time required for cooling one of the molds, then productivity compared to normal molding is improved by a maximum of two times. That is, in addition to suppressing cost increases, there is the merit that it is possible to realize high productivity.

A technique for heat and cool molding is known. In this technique, the mold is heated in advance to a temperature higher than the thermal deformation temperature of the resin, and after the resin is injected into the mold, the mold is cooled. While this technique can prevent appearance defects of molded parts, it requires an apparatus for forced heating and cooling. In addition, there is a disadvantage that the molding process is longer than that of a typical molding method.

In order to produce different types of molded parts, an operation for unloading a first type of mold from an injection molding machine and loading a new and different type of mold into the injection molding machine is known. What is needed is an ability to efficiently produce three or more different types of molded parts.

### SUMMARY

A method for injection molding system that manufactures a molded part with an injection molding machine, the method comprising conveying a first mold between a first position for performing an injection molding process and a second position for performing a cooling process, conveying a second mold between the first position and a third position for performing the cooling process, performing the injection molding process on the mold located at the first position, performing a removal process for removing a molded part from the mold after completion of the cooling process, exchanging the first mold for a third mold when a number of molded parts associated with the first mold are removed reaches a predetermined number, wherein the second mold and the third mold are conveyed, and controlling, during at least a part of exchanging the first mold and the third mold such that the injection molding process, the cooling process, and the removal process are performed without conveying the second mold between the first position and the third position.

This and other embodiments, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 illustrates an injection molding system.

FIG. 2 illustrates a control process of an injection molding system.

FIG. 3 illustrates an example operation list associated with a corresponding mold.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF EXEMPLARY EMBODIMENTS

The present disclosure has several embodiments and relies on patents, patent applications and other references for details known to those of the art. Therefore, when a patent, patent application, or other reference is cited or repeated herein, it should be understood that it is incorporated by reference in its entirety for all purposes as well as for the proposition that is recited.

With reference to the drawings, the arrow symbols X and Y in each Figure indicate horizontal directions that are orthogonal to each other, and the arrow symbol Z indicates a vertical (upright) direction with respect to the ground.

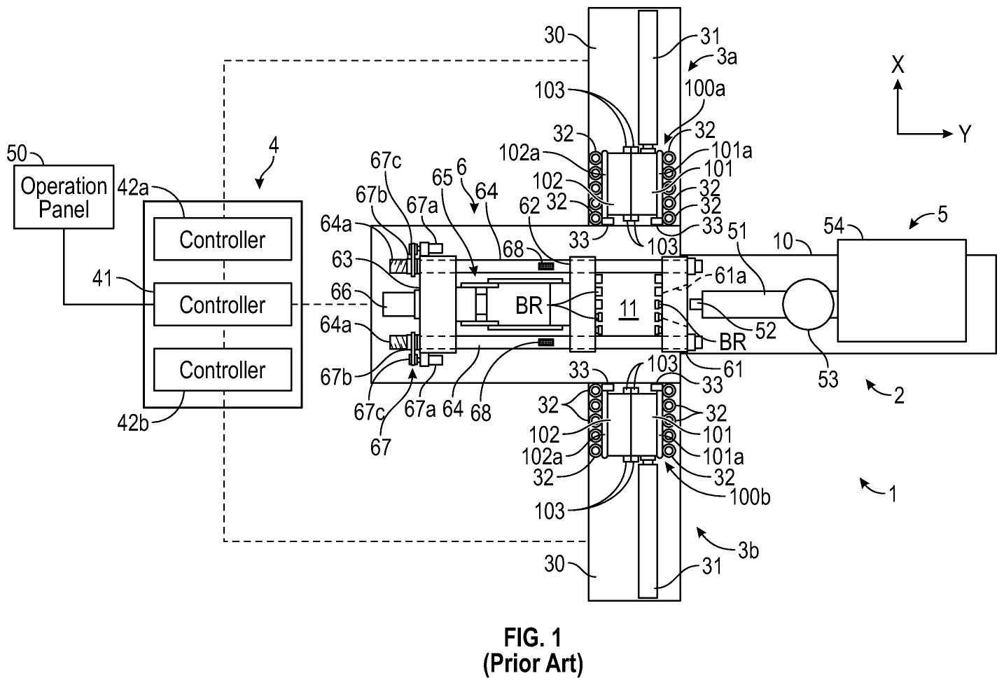

FIG. 1 illustrates injection molding system 1 of US 2018/0009146/Japanese patent publication No. 2018-001738/VN20160002505 and are being provided herein for information/description purposes only.

The injection molding system 1 includes an injection molding machine 2, conveying machines 3A and 3B, and a control apparatus 4. The injection molding system 1 manufactures a molded part while alternating a plurality of molds using the conveying machines 3A and 3B for the one injection molding machine 2. Two molds, 100A and 100B are used.

The mold 100A/100B is a pair of a fixed mold 101 and a movable mold 102, which is opened/closed in relation to the fixed mold 101. The molded part is molded by injecting a molten resin into a cavity formed between the fixed mold 101 and the movable mold 102. Clamping plates 101a and 102a are respectively fixed to the fixed mold 101 and the movable mold 102. The clamping plates 101a and 102a are used to lock the mold 100A/100B to a molding operation position 11 (mold clamping position) of the injection molding machine.

For the mold 100A/100B, a self-closing unit 103 is provided for maintaining a closed state between the fixed mold 101 and the movable mold 102. The self-closing unit 103 enables preventing the mold 100A/100B from opening after unloading the mold 100A/100B from the injection molding machine 2. The self-closing unit 103 maintains the mold 100A/100B in a closed state using a magnetic force. The self-closing unit 103 located at a plurality of locations along opposing surfaces of the fixed mold 101 and the movable mold 102. The self-closing unit 103 is a combination of an element on the side of the fixed mold 101 and an element on the side of the movable mold 102. For the self-closing unit 103, typically two or more pair are installed for one of the molds 100A and 100B.

A conveying machine 3A loads and unloads the mold 100A onto/from the molding operation position 11 of the injection molding machine 2. A conveying machine 3B loads and unloads the mold 100B onto/from the molding operation position 11. The conveying machine 3A, the injection molding machine 2, and the conveying machine 3B are arranged to be lined up in this order in the X-axis direction. In other words, the conveying machine 3A and the conveying machine 3B are arranged laterally with respect to the injection molding machine 2 to sandwich the injection molding machine 2 in the X-axis direction. The conveying machines 3A and 3B are arranged to face each other, and the conveying machine 3A is arranged on one side laterally of the injection molding machine 2, and the conveying machine 3B is arranged on the other side respectively adjacent. The molding operation position 11 is positioned between the conveying machine 3A and the conveying machine 3B. The conveying machines 3A and 3B respectively include a frame 30, a conveyance unit 31, a plurality of rollers 32, and a plurality of rollers 33.

The frame 30 is a skeleton of the conveying machine 3A and 3B, and supports the conveyance unit 31, and the pluralities of rollers 32 and 33. The conveyance unit 31 is an apparatus that moves the mold 100A/100B back and forth in the X-axis direction, and that removes and inserts the mold 100A/100B in relation to the molding operation position 11.

The conveyance unit 31 is an electrically driven cylinder with a motor as a driving source, and includes a rod that moves forward/backward in relation to the cylinder. The cylinder is fixed to the frame 30, and the fixed mold 101 is fixed to the edge portion of the rod. For the conveyance unit 31 both a fluid actuator and an electric actuator can be used, where the electric actuator can provide better precision of control of the position or the speed when conveying the mold 100A/100B. The fluid actuator can be an oil hydraulic cylinder, or an air cylinder, for example. The electric actuator can, in addition to an electrically driven cylinder, be a rack-and-pinion mechanism with a motor as the driving source, a ball screw mechanism with a motor as the driving source, or the like.

The conveyance unit 31 is arranged independently for each of the conveying machines 3A and 3B. However, a common support member that supports the molds 100A and 100B can be used, and a single common conveyance unit 31 can be arranged for this support member. A case where the conveyance unit 31 is arranged independently for each of the conveying machines 3A and 3B enables handling cases where a movement strokes differ between the mold 100A and the mold 100B when conveying. For example, a case in which molds cannot be conveyed simultaneously since the widths of the molds (the width in the X direction) differ or the thickness of the molds (the width in the Y direction) differ.

The plurality rollers 32 configure a row of rollers arranged in the X-axis direction, where two rows are configured separated in the Y-axis direction. The plurality of rollers 32 rotate around the axis of revolution in the Z-axis direction, and guide movement in the X-axis direction of the mold 100A/100B contacting the side surfaces of the mold 100A/100B (the side surfaces of the clamping plates 101a and 102a) and supporting the mold 100A/100B from the side. The plurality rollers 33 configure a row of rollers arranged in the X-axis direction, where two rows are configured separated in the Y-axis direction. The plurality of rollers 33 rotate around the axis of revolution in the Y direction, and cause movement in the X direction of the mold 100A/100B to be smooth, supporting the bottom surfaces of the mold 100A/100B (the bottom surfaces of the clamping plates 101a and 102a) and supporting the mold 100A/100B from below.

The control apparatus 4 includes a controller 41 for controlling the injection molding machine 2, a controller 42A for controlling the conveying machine 3A, and a controller 42B for controlling the conveying machine 3B. Each of the controllers 41, 42A and 42B includes, for example, a processor such as a CPU, a RAM, a ROM, a storage device such as a hard disk, and interfaces connected to sensors or actuators (not illustrated). The processor executes programs stored in the storage device. An example of a program (control) that the controller 41 executes is described below. The controller 41 is communicably connected with the controllers 42A and 42B, and provides instructions related to the conveyance of the mold 100A/100B to the controllers 42A and 42B. The controllers 42A and 42B, if loading and unloading of the mold 100A/100B terminates, transmit a signal for operation completion to the controller 41. In addition, the controllers 42A and 42B transmit an emergency stop signal at a time of an abnormal occurrence to the controller 41.

A controller is arranged for each of the injection molding machine 2, the conveying machine 3A, and the conveying machine 3B, but one controller can control all three machines. The conveying machine 3A and the conveying machine 3B can be controlled by a single controller for more reliable and collaborative operation.

An operation panel 50 (display) is connected to the control apparatus 4. When a user operates the operation panel 50, the control apparatus 4 receives a user instruction from the operation panel 50. Information about the injection molding system 1 is displayed on the operation panel 50. The operation panel 50 can be provided on the injection molding machine 2 or either of the conveying machine 3A and 3B. The operation panel 50 can be provided external to the injection molding machine 2, and the conveying machines 3A and 3B.

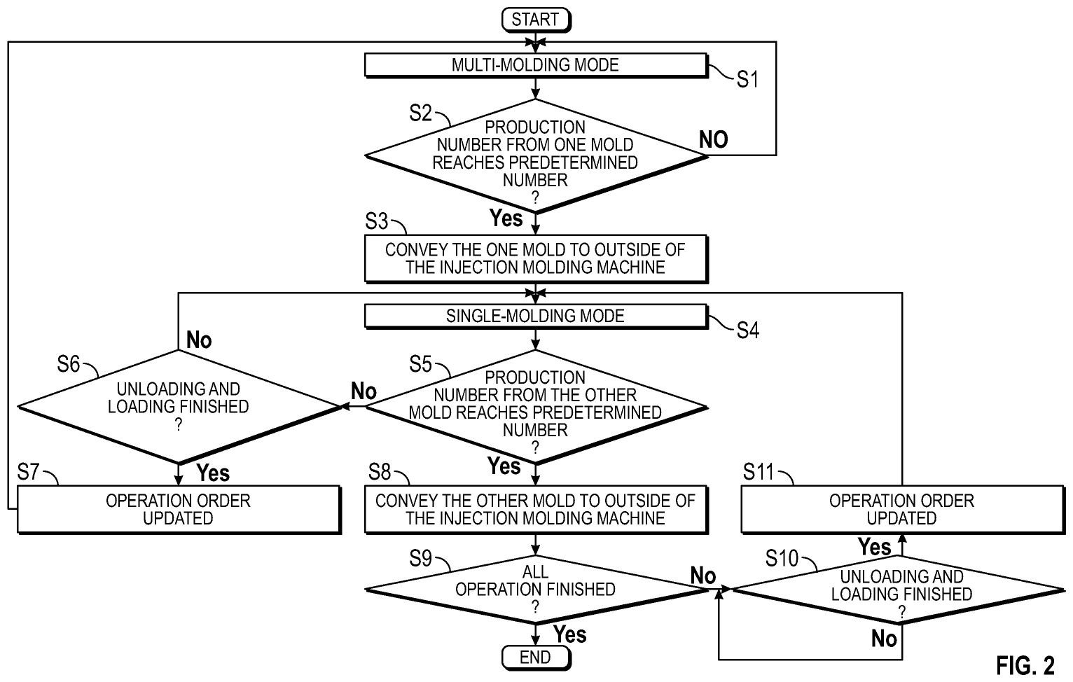

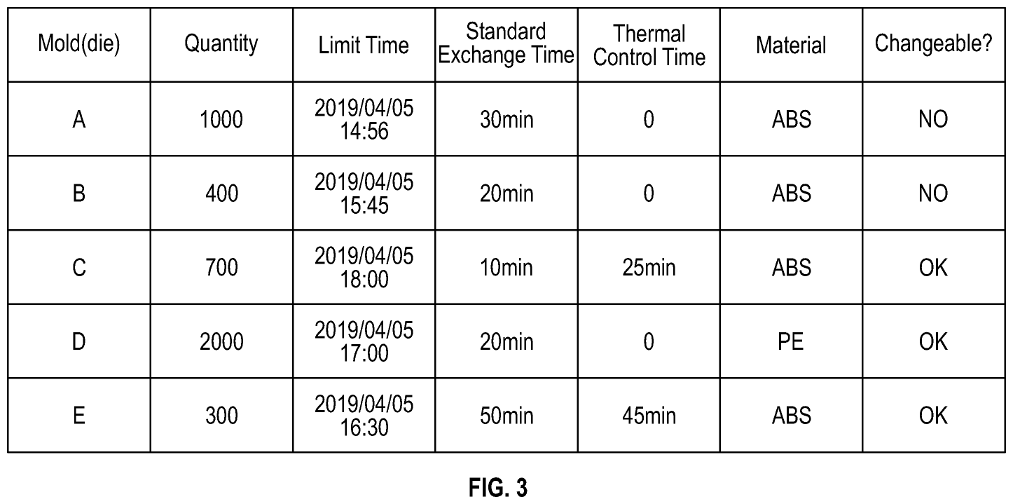

FIG. 2 illustrates a control process of an injection molding system according to an exemplary embodiment. The control process is achieved by the controller 41 controlling the injection molding machine 2 and the conveying machines 3A and 3B via the controllers 42A and 42B. A program for performing the control process is stored in the memory (not illustrated) and executed by the controller 41. The memory also stores an operation list for instructing a series of operations in a case where using three or more molds. The operation list stores information of each mold based on a production order. An example of the operation list is illustrated in FIG. 3.

The information of each mold in the present exemplary embodiment includes a production number using the mold (quantity), time to manufacture the quantity of molded part using the mold (limit time), estimated time duration for exchanging the mold (standard exchange time), estimated time duration to warm the mold to be ready for injection molding (thermal control time), molding material to be injected into the mold (material), and information indicating whether the order of production using the mold is changeable (changeable). This list is not seen to be limiting, and any information that would enable practice of the present embodiment is applicable.

With respect to the standard exchange time, the estimation is based on the sum of the standard exchange time for a mold to be removed and the standard exchange time for mole to be replaced. For example, if mold A is to be exchanged for mold C, the exchange time is estimated to be 40 minutes (30 minutes for mold A and 10 minutes for mold C). The standard exchange time is typically dependent on the weight of the mold, but any factor that would enable calculation of the standard exchange time is applicable.

As illustrated in the example of FIG. 3, the injection molding process is executed in the order of A->B->C->D->E. In this example, since the time limit for both mold A and mold B are close to the current time, the process order for each mold cannot be changed. Since the time limit for mold C, mold D, and mold E are not close to the current time, the process order for each of these molds is changeable.

Before the process illustrated in FIG. 2 is executed, mold 100A and mold 100B are loaded onto conveying machine 3A and conveying machine 3B respectively based on the operation list.

Turning to FIG. 2, in step S1, injection molding using the mold 100A and the mold 100B B alternately is performed (multi-molding mode). The multi-molding mode is a mode where a mold is changed each time an injection molding is performed.

Different processes performed in S1 for different cases, Case 1, Case 2, and Case 3. Case 1 is a case where processes in step S1 are performed for the first time with each mold. Case 2 is a case in which processes in step S1 are performed for a second or later time (following step S2). Case 3 is a case in which processes in step S1 are performed following step S7.

Case 1 will now be described. For description purposes, the mold 100A is conveyed into the molding operation position 11 of the injection molding machine 2 before the mold 100B is conveyed into the molding operation position 11. Case 1 includes the execution of several processes. For description purposes, each of the processes are labeled.

Process 1: The fixed platen 61 and the moveable platen 62 automatically close and the contact with the mold 100A in response to the mold 100A being conveyed to molding operation position 11. The fixed platen 61 and the moveable platen 62 secure the mold 100A.

Process 2: The mold 100A is then fixed to both the fixed platen 61 and the movable platen 62 by driving the fixing mechanisms 610.

Process 3: The mold 100A is clamped by the fixed platen 61 and the movable platen 62 by driving the motor 66 to drive the toggle mechanism 65.

Process 4: Once the mold 100A has been fixed and clamped, the processes of injection a molding material, e.g., molten resin, into the mold 100A and dwelling are performed.

Process 5: The injecting apparatus 5 is driven to fill molding material into a cavity in the mold 100A from the nozzle 52. The molding material is then pressed in the cylinder 51 into the mold 100A at a high pressure to compensate for a volume decrease due to solidification of the molding material.

Process 6: The fixing mechanism 610 then releases the mold 100A, which removes the clamping force, and the movable platen 62 slightly separates from the fixed platen 61.

Process 7: After a delay of a predetermined time after the mold 100A is released, the motor 66 is driven to drive the toggle mechanism 65. That is, the fixed platen 61 and the moveable platen 62 move to a retreat position where they do not contact the mold 100A.100B being conveyed by the conveying machine 3A/3B. This movement of the fixed platen 61 and moveable platen 62 generates a space between them for alternating (changing) the molds 100A and 100B.

Based on the above-described process, the mold 100A is in a state where the molding material has been injected into the mold 100A and the mold 100A is not fixed between the fixed platen 61 and the moveable platen 62. The mold 100A is then conveyed out of the molding operation position 11 and the mold 100B is conveyed into the molding operation position 11. The above-described processes are then performed with the mold 100B.

While the above-described processes are performed with the mold 100B, the cooling process is performed for the mold 100A on the conveying machine 3A. In the cooling process the mold 100A is cooled to a predetermined temperature during a predetermined time period.

A mold typically includes a channel running through it where a temperature controller is connected, via a hose, to an interface of the channel formed on a surface of the mold, while the mold is prepared for injection molding. A fluid flows from the temperature controller to the mold to keep the mold at a predetermined temperature. During the injection molding processes, including the cooling process, fluid is usually always running inside the mold.

After the mold 100A is conveyed out of the molding operation position 11 to the conveying machine 3A, the mold 100A is typically still heated from the melted molding material injected into the mold 100A. In the cooling process, the fluid from the temperature controller causes the temperature of the mold 100A to fall to a predetermined temperature. The cooling process continues until a predetermined time period passes from the start of the cooling process.

Upon completion of the above-described processes for the mold 100B, the conveying machine 3B conveys the mold 100B out of the molding operation position 11 and the conveying machine 3A conveys the mold 100A into the molding operation position 11. When the mold 100A is conveyed, the cooling process performed for the mold 100A at the conveying machine 3A may be completed. However, if the cooling process has not completed the injection molding machine 2 waits for the cooling process to complete. With respect to the mold 100B, the cooling process is performed on the conveying machine 3B.

Process 8: After Process 1 and Process 2 are performed with the mold 100A, the movable platen 62 is separated from the fixed platen 61 by driving the motor 66. The fixed mold 101 is fixed to the fixed platen 61 by the fixing mechanisms 610, and the movable mold 102 is fixed to the movable platen 62 by the fixing mechanisms 610, and therefore the movable mold 102 separates from the fixed mold 101 and the mold 100 is opened against the magnetic force of the self-closing unit 103.

Process 9: A molded part remaining that remains on the side of the movable mold 102 of the mold 100A/100B is removed by driving the take-out robot 7 and conveyed outside of the injection molding machine 2.

In S2, a determination is made whether the production number of the molded parts from one mold reaches a predetermined number. More specifically, it is determined whether the injection molding using the one mold is finished. The predetermined number is specified by an operation list, an example of which is illustrated in FIG. 3. If the production number does not reach the predetermined number, the process returns to S1 and the multi-molding mode process continues.

Case 2, which is when the process returns to S1 from S2 will now be performed. In Case 2, the mold 100A is positioned at the molding operation position 11 of the injection molding machine 2, and a molded part was just removed by the take-out robot 7. The injection molding machine 2 then performs Process 1 through Process 7 with the mold 100A. The mold 100A is conveyed out, and the mold 100B is conveyed in. The mold 100A is subjected to a cooling process at the conveying machine 3A.

The injection molding machine 2 then performs each of Process 1, Process 2, Process 8, and Process 9 in this order with the mold 100B. Then S1 ends in Case 2, and the process proceeds to the S2.

As described above, when the process returns from S2 to S1, which is the second time for a mold to be used in S1, Process 3 through Process 7 is performed for a mold, a mold is changed, and then Process 1, Process 2, Process 8, and Process 9 are performed with the other mold.

In Case 3, where the process proceeds returns from S7 to S1, a mold is at the molding operation position 11, a molded part has just been removed, and the other mold is on the conveying machine without having any molding material in it. In this case, with one mold in the molding operation position 11) Process 3 through Process 7 is performed, the mold is changed, and Process 3 through Process 7 is performed with the other mold , the other mold is changed, and Process 1, Process 2, Process 8, and Process 9 are then performed with the one mold.

If the production number reaches the predetermined number in S2, the process proceeds to S3 and the one mold is conveyed out of the injection molding machine 2 to a conveying machine. The one mold is unloaded from the conveying machine a new mold is loaded onto the conveying machine. During unloading of a mold, a cable that provides electricity to the mold and hoses that provide fluid to the mold for temperature control are disconnected from the mold. During loading of a mold, the cable and the hoses are connected to the mold.

Next, in S4, injection molding using the other mold is performed (single-molding mode). In this mode, the injection molding with the other mold is continuously performed. In S4, different processes are performed in different cases (Cases 4, 5, and 6). In Case 4, the process proceeds from S3 to S4 (it is not clear how Case 4 can proceed from S3 when Case 4 is a process in S4). In Case 5, the process returns from S6, described below, to S4. In Case 6, the process returns from S11, described below, to S4.

In Case 4, there is no mold at the molding operating position 11, a mold with which injection molding is completed and a mold with which a cooling process is being performed are both on their respective conveying machines. In S4, ae conveying machine conveys the one into the molding operation position 11, Process 1, Process 2, Process 8, and Process 9 are performed in this order, and a molded part is removed. The process then proceeds to S5.

In S5, it is determined whether the production number of the molded parts from the other mold reaches a predetermined number. That is, it is determined whether the injection molding using the other mold is completed. The predetermined number is specified by, for example, the operation list in FIG. 3.

If the production number does not reach the predetermined number, the flow proceeds to S6, where it is determined whether the one mold is already unloaded and a new mold is already loaded. If the one mold is not unloaded and the new mold is not loaded, the flow returns to S4.

In Case 5, where the process returns from S6 to S4, a mold from which a molded part has just been removed, is at the molding operation position 11. In this case, in step S4 the injection molding machine 2 performs Process 3 through Process 5. Next, the cooling process is performed at the molding operation position 11 inside the injection molding machine 2. Because in the single-molding mode the cooling process is performed inside the injection molding machine 2, Process 6 and Process 7 are not performed. After the cooling process, Process 8 and Process 9 are performed, and a molded part is removed. The process then proceeds to S5.

In Case 6, where the process returns from S11, described below, to S4, a mold is ready and the other mold is not ready. In S4, Process 1 through Process 7 are performed with the mold. Process 8 and Process 9 are performed with the mold, and then a molded part is removed from the mold. Case 6 ends and the process then proceeds to S5.

Returning to S6, if the one mold is already unloaded and a new mold is already loaded, flow proceeds to S7, where the operation order of the list is updated. The updating process is executed in a case where the time to unload a mold and load a new mold was long or the unloading and loading operation completed earlier compared to a standard exchange time. The updating process is also executed in a case where it is determined that the remaining operation will complete earlier if the operation order is changed. If it is determined that the operation order does not have to be changed, the updating process is not executed. After starting the updating process in S7, the process returns to S1.

Returning to S5, if the production number reaches the predetermined number, the process proceeds to S8. In S8 the other mold is moved out to the conveying machine. The other mold is unloaded from the conveying machine and a new mold loaded onto the conveying machine. At this time, it is preferable to display the information on the operation panel 50 like S3 for requesting a user to unload the other mold and load the new mold. In a case where the one mold is not yet unloaded and the operation time for exchanging the mold is longer than the standard exchange time on the operation list, the operation panel 50 can display a warning.

In step S9, it is determined whether the entire operation is complete. If the entire operation is completed, the process ends. If the entire operation is not completed, flow proceeds to S10. In S10, it is determined whether the one mold or the other mold is already unloaded and new mold is already loaded in step S10.

If the one mold and the other mold are not yet unloaded and a new mold is not yet loaded, S10 is re-executed. If the one mold or the other mold is already unloaded and a new mold is already loaded, the process proceeds to S11. In S11, the operation order is updated and then the process returns to S4.

According to another embodiment, in S10, in a case where only one mold is ready and a new mold is almost ready, the injection molding can be started after the other mold is ready. In this case (Case 7), the process proceeds to S1. In Case 7, both the molds at their respective conveying machines do not include any molding material and the same processes in Case 1 is performed in S1.

According to another embodiment, in S6 and S10, a determination is made whether a mold is loaded or no, based on an operator's input. For example, a switch (not illustrated) is provided for notifying the injection molding machine 2 of completion of loading of the mold. The control apparatus 4 receives a signal output in response to an operator's selection of the switch. In case where the control apparatus 4 receives the signal, the control apparatus 4 determines that the mold is ready.

In the above-described embodiments, clamping, injection/dwelling, opening, and ejection are performed in a state where the mold is at the molding operation position 11, but this is not seen to be limiting. All of the processes do not need to be performed at the molding operation position 11. Some processes can be performed at a position different from the molding operation position 11.

As described above, productivity improves because the molded parts can be manufactured using one mold in the single-molding mode while the other mold is unloaded in a case of manufacturing the molded parts while alternating a plurality of the molds by an injection molding machine. An operation order after unloading and loading molds can be changed, which also improves productivity based on the actual operation environment.

### Definitions

In referring to the description, specific details are set forth in order to provide a thorough understanding of the examples disclosed. In other instances, well-known methods, procedures, components and circuits have not been described in detail as not to unnecessarily lengthen the present disclosure.

It should be understood that if an element or part is referred herein as being “on”, “against”, “connected to”, or “coupled to” another element or part, then it can be directly on, against, connected or coupled to the other element or part, or intervening elements or parts may be present. In contrast, if an element is referred to as being “directly on”, “directly connected to”, or “directly coupled to” another element or part, then there are no intervening elements or parts present. When used, term “and/or”, includes any and all combinations of one or more of the associated listed items, if so provided.

Spatially relative terms, such as “under” “beneath”, “below”, “lower”, “above”, “upper”, “proximal”, “distal”, and the like, may be used herein for ease of description to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable.

The term “about,” as used herein means, for example, within 10%, within 5%, or less. In some embodiments, the term “about” may mean within measurement error.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

The terminology used herein is for the purpose of describing particular embodiments only and is not intended to be limiting. The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “includes”, “including,” and “containing” are to be construed as open-ended terms (i.e., meaning “including, but not limited to,”) unless otherwise noted. Specifically, these terms, when used in the present specification, specify the presence of stated features, integers, steps, operations, elements, and/or components, but do not preclude the presence or addition of one or more other features, integers, steps, operations, elements, components, and/or groups thereof not explicitly stated. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

It will be appreciated that the methods and compositions of the instant disclosure can be incorporated in the form of a variety of embodiments, only a few of which are disclosed herein. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Combinations of any exemplary embodiments disclosed above are also included as embodiments of the present disclosure. While the above-described exemplary embodiments discuss illustrative embodiments, these embodiments are not seen to be limiting.

What is claimed is:

1. A method for an injection molding system that manufactures a molded part with an injection molding machine, the method comprising:
conveying a first mold between a first position for performing an injection molding process and a second position for performing a cooling process;
conveying a second mold between the first position and a third position for performing the cooling process;
performing the injection molding process on the mold located at the first position;
performing a removal process for removing a molded part from the mold after completion of the cooling process;
exchanging the first mold for a third mold when a number of molded parts associated with the first mold are removed reaches a predetermined number, wherein the second mold and the third mold are conveyed, and
controlling, during at least a part of exchanging the first mold and the third mold such that the injection molding process, the cooling process, and the removal process are performed without conveying the second mold between the first position and the third position.

2. The method according to claim 1, further comprising storing manufacturing procedure information for executing the injection molding process, the cooling process, and the removal process with three or more molds.

3. The method according to claim 1, further comprising changing, after changing to the third mold is completed, an operation order of molds to be used after the third mold.

4. The method according to claim 3, wherein changing of the operation order is based on one or more of an operation time for changing a mold, a time for adjusting a temperature of a mold, molding material used in a mold, or information indicating whether the operation order using a mold is changeable.

5. The method according to claim 1, further comprising displaying, after manufacturing the predetermined number of molded parts using the first mold, information to request a change from the first mold to the third mold.

6. A non-transitory computer readable medium storing a program that causes a computer to execute a method, the method comprising:
conveying a first mold between a first position for performing an injection molding process and a second position for performing a cooling process;
conveying a second mold between the first position and a third position for performing the cooling process;
performing the injection molding process on the mold located at the first position;
performing a removal process for removing a molded part from the mold after completion of the cooling process;
exchanging the first mold for a third mold when a number of molded parts associated with the first mold are removed reaches a predetermined number, wherein the second mold and the third mold are conveyed, and
controlling, during at least a part of exchanging the first mold and the third mold such that the injection molding process, the cooling process, and the removal process are performed without conveying the second mold between the first position and the third position.

7. An injection molding system comprising:
an injection molding machine;
a conveying apparatus configured to change between multiple molds;
a controller; and
a memory configured to store a program that causes the controller to execute a manufacturing process,
wherein an improvement to the injection molding system includes the controller executing a manufacturing process of:
conveying a first mold between a first position for performing an injection molding process and a second position for performing a cooling process;
conveying a second mold between the first position and a third position for performing the cooling process;
performing the injection molding process on the mold located at the first position;
performing a removal process for removing a molded part from the mold after completion of the cooling process;
exchanging the first mold for a third mold when a number of molded parts associated with the first mold are removed reaches a predetermined number, wherein the second mold and the third mold are conveyed, and
controlling, during at least a part of exchanging the first mold and the third mold such that the injection molding process, the cooling process, and the removal process are performed without conveying the second mold between the first position and the third position.

8. The injection molding system according to claim 7,
wherein the controller is configured to control the injection molding machine to operate in a first mode and a second mode,
wherein in the first mode the controller is configured to control the injection molding machine to manufacture molded parts with the first and the second mold while changing the first mold and the second mold, and
wherein in the second mode the controller is configured to control the injection molding machine to manufacture molded parts with one mold of the first mold and the second mold and to cool the one mold at a molding operation position in the injection molding machine.

9. The injection molding system according to claim 8, wherein in the first mode, the controller is configured to control the injection molding machine to inject material into the first mold at the molding operation position while the second mold is being cooled at a position different from the molding operation position.
